(19) United States
(12) Patent Application Publication
(10) Pub. No.: US 2024/0093919 A1
(43) Pub. Date: Mar. 21, 2024

(54) PROCESS VACUUM SYSTEM WITH CONDENSER AND DUAL EJECTORS

(71) Applicant: Graham Corporation, Batavia, NY (US)

(72) Inventors: William Joseph Kubik, Basom, NY (US); Christopher Donald Przybysz, Corfu, NY (US); Peter Richard Corbelli, JR., Batavia, NY (US)

(21) Appl. No.: 18/468,778

(22) Filed: Sep. 18, 2023

Related U.S. Application Data
(60) Provisional application No. 63/376,111, filed on Sep. 19, 2022.

(51) Int. Cl. F25B 39/04; B01J 19/00; F25B 41/42

(52) U.S. Cl. CPC F25B 39/04; B01J 19/0053; F25B 41/42; B01J 2219/00416; F25B 2339/045; F25B 2339/047

(57) ABSTRACT

A vacuum system, including a condenser including a first inlet, a first outlet, and a second outlet, a first ejector connected to a motive fluid source, and a second ejector connected to the motive fluid source and the condenser.

### CROSS-REFERENCE TO RELATED APPLICATIONS

This application claims the benefit under 35 U.S.C. § 119(e) of U.S. Provisional Application No. 63/376,111, filed Sep. 19, 2022, which application is incorporated herein by reference in its entirety.

### FIELD

The present disclosure relates generally to ejector vacuum systems, and more particularly, to process vacuum systems used to create vacuum on vessels that require evacuation followed by a steady state or other operating condition.

### BACKGROUND

Evacuation of a vessel and vacuum required by process vacuum systems can be created via a number of suitable means, for example, using an ejector. An ejector requires a motive fluid such as steam flowing at changing velocities to create low pressure (vacuum). In cases where high condensable loads exist, process vacuum condensers may be used in conjunction with ejectors to condense process vapors to reduce ejector size and thereby save motive fluid and reduce energy costs.

Some process systems have an evacuation requirement followed by a steady state operating condition (i.e., a continuously running cycle). However, current process systems require a large amount of motive fluid in order to provide satisfactory performance suitable for evacuation and a subsequent steady state operating condition.

### SUMMARY

In view of the forgoing, it is an object of the present disclosure to provide a system and method that optimizes and reduces motive fluid usage while still providing suitable vacuum for process vessels.

An exemplary embodiment of the present disclosure provides a vacuum system, including a condenser including a first inlet, a first outlet, and a second outlet, a first ejector connected to a motive fluid source, and a second ejector connected to the motive fluid source and the condenser.

In some embodiments, the vacuum system further includes a process vessel. In some embodiments, the process vessel is a reactor vessel, and at least one of the first ejector and the second ejector are operatively arranged to evacuate the reactor vessel. In some embodiments, the first inlet is fluidly connected to the process vessel. In some embodiments, the condenser is operatively arranged to condense vapor from the process vessel into a condensate. In some embodiments, the condensate exits the condenser via the first outlet. In some embodiments, the second outlet is fluidly connected to the second ejector. In some embodiments, the condenser further includes a cooling fluid inlet and a cooling fluid outlet. In some embodiments, the condenser is a shell and tube condenser. In some embodiments, the vacuum system further includes downstream equipment connected to at least one of the first ejector and the second ejector. In some embodiments, at least one of the first ejector and the second ejector includes an inlet nozzle connected to a motive fluid source, a suction chamber, and a diffuser.

An exemplary embodiment of the present disclosure provides a process vacuum system, including a first ejector connected to a motive fluid source, a condenser including a first inlet, a first outlet, and a second outlet, a second ejector connected to the motive fluid source and the condenser, and downstream equipment fluidly connected to at least one of the first ejector and the second ejector. In some embodiments, the process vacuum system further includes a process vessel. In some embodiments, the first inlet is fluidly connected to the process vessel. In some embodiments, the condenser is operatively arranged to condense vapor from the process vessel into a condensate, and the condensate exits the condenser via the first outlet. In some embodiments, the second outlet is fluidly connected to the second ejector. In some embodiments, the condenser further includes a cooling fluid inlet and a cooling fluid outlet. In some embodiments, the condenser is a shell and tube condenser. In some embodiments, at least one of the first ejector and the second ejector includes an inlet nozzle connected to the motive fluid source, a suction chamber, and a diffuser. In some embodiments, the first ejector and the condenser are arranged in parallel.

An exemplary embodiment of the present disclosure provides a first ejector connected to a motive fluid source that is sized according to the evacuation requirements. In addition, a process vacuum condenser is provided, including a condenser including a first inlet, a first outlet, and a second outlet, and a second ejector connected to the motive fluid source and the condenser.

In some embodiments, the process vessel is a reactor, for example for a propane dehydrogenation (PDH) chemical process. In some embodiments, the first inlet is fluidly connected to the process vessel or reactor. In some embodiments, the condenser is operatively arranged to condense vapor from the process vessel into a condensate. In some embodiments, the condensate exits the condenser via the first outlet. In some embodiments, the second outlet is fluidly connected to the second ejector. In some embodiments, the condenser further comprises a cooling fluid inlet and a cooling fluid outlet. In some embodiments, the condenser is a shell and tube condenser. In some embodiments, each of the first ejector and the second ejector comprise an inlet nozzle connected to a motive fluid source, a suction chamber, and a diffuser.

In some embodiments, the vacuum system further comprises one or more inlet valves operatively arranged to isolate the vacuum systems (i.e., the ejectors) according to need. The one or more valves may be automatic or manually actuated.

An exemplary embodiment of the present disclosure provides a first ejector including a first inlet, a first outlet, and a first motive connection that is connected to a motive fluid source. In addition, a process vacuum condenser is provided, including a first inlet, a first outlet, and a second outlet, and a second ejector connected to a motive fluid source, including a first inlet, a first outlet, and a motive fluid connection. In some embodiments the first ejector is connected to a first motive source and the second ejector is connected to a second motive source, the second motive source being different than the first motive source. In some embodiments, the first ejector is arranged in parallel with the condenser and second ejector.

These and other objects, features, and advantages of the present disclosure will become readily apparent upon a review of the following detailed description of the disclosure, in view of the drawings and appended claims.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure, in which corresponding reference symbols indicate corresponding parts. However, the drawings do not illustrate all possible implementations of the presently disclosed subject matter and are not intended to limit the scope of the present disclosure in any way.

FIG. 1 is a functional diagram illustrating a vacuum system, in accordance with exemplary embodiments of the present disclosure.

FIG. 2 is a chart illustrating attributes of the process vacuum system shown in FIG. 1 compared with attributes of current systems.

FIG. 3 is a chart illustrating attributes of the process vacuum system shown in FIG. 1 compared with attributes of current systems.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element. A similar interpretation is intended when the phrase “used in at least one of:” is used herein.

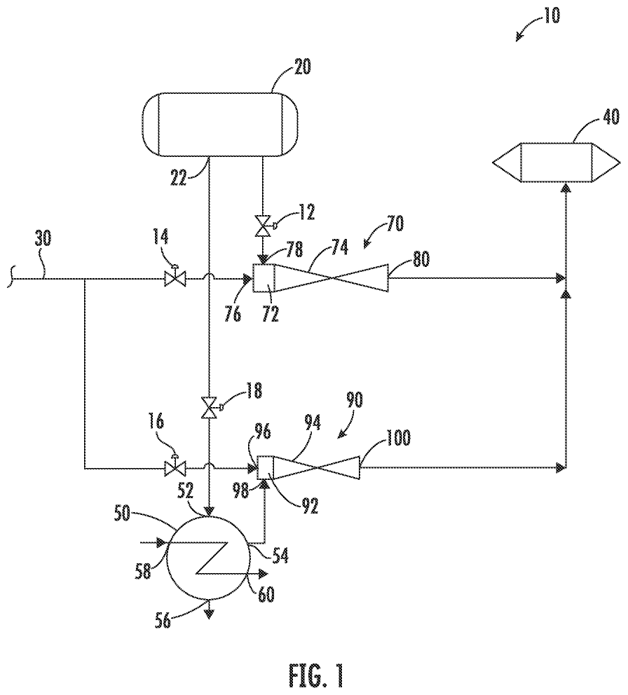

Referring now to the figures, FIG. 1 is a diagram illustrating vacuum system 10, in accordance with some embodiments of the present disclosure. Vacuum system 10 may comprise one or more of process vacuum condenser or condenser 50, and at least one ejector, for example ejector 70 and ejector 90.

Evacuation ejector 70 generally comprises suction chamber 72 and diffuser 74. Suction chamber 72 comprises motive fluid inlet 76 and vapor or flare gas inlet 78. Motive inlet 76 also comprises a nozzle which is connected to motive fluid source via inlet 30. In some embodiments, the motive fluid is steam. The motive fluid flows through the nozzle of inlet 76 and accelerates at the tip thereof, thereby creating a vacuum and drawing vapors into suction chamber 72 via inlet 78. In some embodiments, vapor inlet 78 is fluidly connected to reactor 20. The vapors are drawn into suction chamber 72 due to low pressure (vacuum) created by the nozzle of inlet 76, mixing with the motive fluid. The motive fluid and vapors then travel through diffuser 74 where the velocity of the fluids is decreased and the pressure is increased. The vapors and motive fluid exit ejector 70 via outlet 80. In some embodiments, outlet 80 is fluidly connected to downstream equipment 40, for example a waste heat boiler. In such embodiments, the vapors and motive fluid leave ejector 70 and ejector 90 and enter downstream equipment 40, which may recover the energy in the fluids and convert it into useful and effective thermal energy. It should be appreciated that ejectors 70 and 90 are operatively arranged to cause vacuum in vessel 20, specifically, via suction chambers 72 and 92. In some embodiments, suction chamber 92 is fluidly connected to process vacuum condenser 50, as will be described in greater detail below.

In some embodiments, process vacuum condenser 50 is connected to a process vessel, for example, reactor 20. Reactor 20, in one embodiment, is a reactor vessel that is used in plastics manufacturing, and comprises outlet 22 for removing noncondensables and/or condensable vapors during the evacuation process, removing noncondensable and/or condensable vapors during the reaction process under vacuum, and removing air, condensable vapors, and/or coke products during catalyst regeneration under high temperature and vacuum conditions. In some embodiments, the vapors may include air, various hydrocarbons, steam, and/or other vapors.

Condenser 50 is operatively arranged to condense vapors from reactor vessel 20 and create condensate therefrom during the steady state operation. Condenser 50 comprises vapor inlet 52, vapor outlet 54, condensate outlet 56, cooling liquid inlet 58, and cooling liquid outlet 60. Vapor inlet 52 is fluidly connected to vapor outlet 22 of reactor vessel 20. Vapor enters condenser 50 via inlet 52. Cooling fluid, for example water, flows into condenser 50 via inlet 58 and out of condenser 50 via outlet 60. The cooling fluid condenses a portion of the vapor in condenser 50 into liquid condensate. The condensate (e.g., hydrocarbons, water, other condensables, etc.) exits condenser 50 via outlet 56. The noncondensed vapors (e.g., air or other vapors) remaining from the condensation process of condenser 50 exits condenser 50 via outlet 54. The vapors exiting outlet 54 are sent to ejector 90, as will be described in greater detail below. It should be appreciated that in some embodiments, noncondensables exiting condenser 50 via outlet 54 may comprise some vapors (e.g., hydrocarbons) depending on how much of the vapor component condenses within condenser 50. In some embodiments, condenser 50 is a shell and tube condenser.

Ejector 90 generally comprises suction chamber 92 and diffuser 94. Suction chamber 92 comprises motive fluid inlet 96 and vapor or flare gas inlet 98. Fluid inlet 96 comprises a nozzle and is connected to motive fluid source or inlet 30. The motive fluid flows through the nozzle of inlet 96 and accelerates at the tip thereof, thereby creating vacuum and drawing vapors into suction chamber 92 via inlet 98. In some embodiments, inlet 98 is fluidly connected to condenser 50. The vapors are drawn into suction chamber 92 due to low pressure created by the nozzle of inlet 96, mixing with the motive fluid. The motive fluid and gas then travel through diffuser 94 where the velocity of the fluids is decreased and pressure is increased. The gas and motive fluid exit ejector 90 via outlet 100. In some embodiments, outlet 100 is fluidly connected to downstream equipment 40. In some embodiments, the vapors and motive fluid leave ejector 90 via outlet 100 and enter waste heat boiler 40 such that heat in the fluids can be recovered and converted into useful and effective thermal energy. It should be appreciated that ejector 90 is operatively arranged to maintain vacuum in condenser 50 and vessel 20, specifically, via suction chamber 92.

In some embodiments, the system comprises one or more valves to direct flow as desired, for example, valves 12, 14, 16, and 18. In some embodiments, valve 12 is fluidly arranged between reactor 20 and ejector 70. In some embodiments, valve 14 is fluidly arranged between motive fluid source 30 and ejector 70. In some embodiments, valve 16 is fluidly arranged between motive fluid source 30 and ejector 90. In some embodiments, valve 18 is fluidly arranged between reactor 20 and condenser 50. The valves can be selectively opened or closed to direct the various fluids as desired. For example, if valve 16 and valve 18 are closed, with valves 12 and 14 opened, process vacuum condenser 50 is isolated from the process vapors, with no condensing action, and evacuation will take place solely via operation of ejector 70. If valve 12 and valve 14 are closed, with valve 16 and valve 18 open, vapors from reactor 20 are condensed in process condenser 50 prior to flowing through ejector 90.

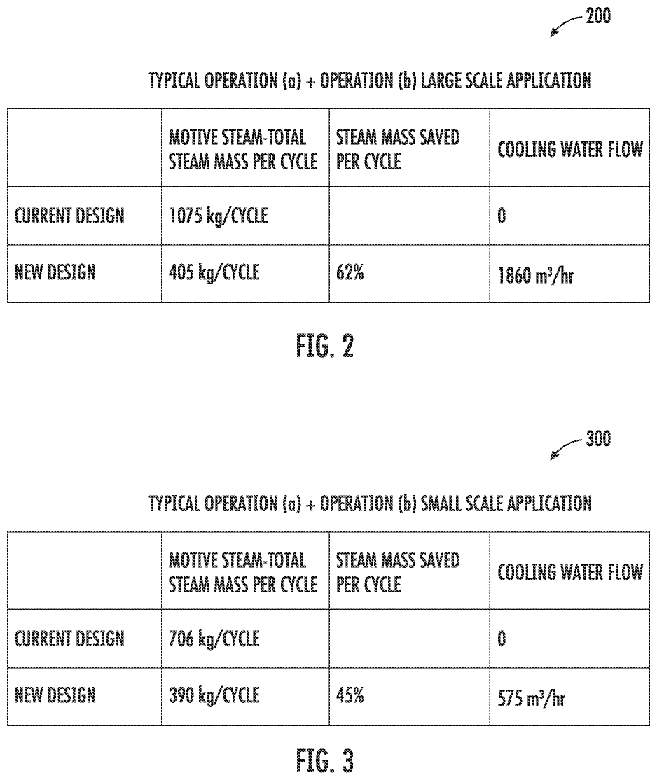

FIG. 2 shows chart 200 illustrating attributes of vacuum system 10 compared with attributes of current systems, in a first example reactor system. Chart 200 illustrates a utility comparison of current vacuum systems compared to vacuum system 10 in a large scale plastics application. Operation (a) refers to motive fluid, specifically steam, and evacuated gas moving through ejector 70. Operation (b) refers to process gas moving through condenser 50 and motive fluid, specifically steam, through ejector 90. The data shown in chart 200 shows motive steam consumption savings. Specifically, in the first example reactor system, current systems utilize 1,075 kg of steam per cycle, whereas vacuum system 10 utilizes only 405 kg of steam per cycle, a difference of 670 kg of steam per cycle and 62% savings in steam.

FIG. 3 shows chart 300 illustrates attributes of vacuum system 10 compared with attributes of current systems, in a second example small scale reactor system. Again, the data of chart 300 indicates motive steam consumption savings. For example, in the example of the second reactor system, current systems utilize 706 kg of steam per cycle, whereas vacuum system 10 utilizes only 390 kg of steam per cycle, a difference of 316 kg of steam per cycle and 45% savings in steam mass per cycle.

In a third example a reactor system requires approximately 100,000 lbs/hour of steam. Vacuum system 10 reduces this steam requirement by 40-60% depending on the motive steam pressure, back pressure of the ejectors, and the total time of operation (a) and (b).

As such, vacuum system 10 is advantageous as it requires less motive steam to function (i.e., create the same vacuum effect on reactor 20). Specifically, by arranging ejector 70 in parallel with the combination of condenser 50 and ejector 90, the same vacuum performance can be achieved using less motive fluid. Benefits of process vacuum condenser 10 include 1) savings in operating costs, 2) reduction in waste, and 3) a reduction in energy consumption.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

### REFERENCE NUMERALS

10 Vacuum System
12 Valve, Inlet
14 Valve, Motive Fluid
16 Valve, Motive Fluid
18 Valve, Inlet
20 Reactor or Process Vessel (under vacuum)
22 Vapor Outlet
30 Motive Fluid Source
40 Downstream Equipment
50 Condenser
52 Vapor Inlet
54 Vapor Outlet
56 Condensate Outlet
58 Cooling Fluid Inlet
60 Cooling Fluid Outlet
70 Ejector
72 Suction Chamber
74 Diffuser
76 Motive Fluid Inlet
78 Vapor Inlet
80 Ejector Outlet
90 Ejector
92 Suction Chamber
94 Diffuser
96 Motive Fluid Inlet
98 Vapor Inlet
100 Ejector Outlet
200 Chart
300 Chart

What is claimed is:

1. A vacuum system, comprising:
a condenser including a first inlet, a first outlet, and a second outlet;
a first ejector connected to a motive fluid source; and
a second ejector connected to the motive fluid source and the condenser.

2. The vacuum system as recited in claim 1, further comprising a process vessel.

3. The vacuum system as recited in claim 2, wherein the process vessel is a reactor vessel, and at least one of the first ejector and the second ejector are operatively arranged to evacuate the reactor vessel.

4. The vacuum system as recited in claim 2, wherein the first inlet is fluidly connected to the process vessel.

5. The vacuum system as recited in claim 1, wherein the condenser is operatively arranged to condense vapor from the process vessel into a condensate.

6. The vacuum system as recited in claim 1, wherein the condensate exits the condenser via the first outlet.

7. The vacuum system as recited in claim 1, wherein the second outlet is fluidly connected to the second ejector.

8. The vacuum system as recited in claim 1, wherein the condenser further comprises a cooling fluid inlet and a cooling fluid outlet.

9. The vacuum system as recited in claim 1, wherein the condenser is a shell and tube condenser.

10. The vacuum system as recited in claim 1, further comprising downstream equipment connected to at least one of the first ejector and the second ejector.

11. The vacuum system as recited in claim 1, wherein at least one of the first ejector and the second ejector comprises:
an inlet nozzle connected to a motive fluid source;
a suction chamber; and
a diffuser.

12. A process vacuum system, comprising:
a first ejector connected to a motive fluid source;
a condenser including a first inlet, a first outlet, and a second outlet;
a second ejector connected to the motive fluid source and the condenser; and
downstream equipment fluidly connected to at least one of the first ejector and the second ejector.

13. The process vacuum system as recited in claim 12, further comprising a process vessel.

14. The process vacuum system as recited in claim 13, wherein the first inlet is fluidly connected to the process vessel.

15. The process vacuum system as recited in claim 13, wherein the condenser is operatively arranged to condense vapor from the process vessel into a condensate, and the condensate exits the condenser via the first outlet.

16. The process vacuum system as recited in claim 13, wherein the second outlet is fluidly connected to the second ejector.

17. The process vacuum system as recited in claim 13, wherein the condenser further comprises a cooling fluid inlet and a cooling fluid outlet.

18. The process vacuum system as recited in claim 13, wherein the condenser is a shell and tube condenser.

19. The process vacuum system as recited in claim 13, wherein at least one of the first ejector and the second ejector comprises:
an inlet nozzle connected to the motive fluid source;
a suction chamber; and
a diffuser.

20. The process vacuum system as recited in claim 13, wherein the first ejector and the condenser are arranged in parallel.
